(19) United States
(12) Patent Application Publication
(10) Pub. No.: US 2026/0249284 A1
(43) Pub. Date: Aug. 27, 2026

(54) PIPETTING INSTRUMENT

(71) Applicant: Beckman Coulter, Inc., Brea, CA (US)

(72) Inventor: Mark Francis SAUERBURGER, Zionsville, IN (US)

(73) Assignee: Beckman Coulter, Inc., Brea, CA (US)

(21) Appl. No.: 18/872,520

(22) PCT Filed: Jun. 6, 2023
(86) PCT No.: PCT/US2023/067992

§ 371 Date: Dec. 6, 2024

Related U.S. Application Data
(60) Provisional application No. 63/349,913, filed on Jun. 7, 2022.
(60) Provisional application No. 63/383,281, filed on Nov. 11, 2022.

(51) Int. Cl. B01L 3/02; G01N 35/10

(52) U.S. Cl. CPC B01L 3/0279; G01N 35/1011; G01N 35/1065; G01N 35/109; G01N 2035/103

(57) ABSTRACT

A pipetting instrument for loading and dispensing a sample is described. The pipetting instrument includes an automated liquid pipettor having a deck for supporting a pipette tip box comprising pipette tips, and mandrels for engaging the pipette tips and withdrawing at least some of the pipette tips from the pipette tip box. The pipetting instrument further includes a controller configured to control the automated liquid pipettor, the controller further configured to execute a pipette tip dislodging operation to dislodge any undesired pipette tips that are withdrawn from the pipette tip box using the mandrels.

This application is being filed on Jun. 6, 2023, as a PCT International Patent application and claims the benefit of and priority to U.S. Provisional Patent Application No. 63/349,913, filed Jun. 7, 2022, and U.S. Provisional Patent Application No. 63/383,281, filed Nov. 11, 2022, the entire disclosures of which are incorporated by reference herein in their entirety.

### BACKGROUND

Pipetting equipment is often used in laboratory settings to reliably transport fluid from one container to another. In commercial laboratory settings, automated liquid pipettors are used to reduce labor costs associated with large pipetting projects while potentially increasing the efficiency, accuracy, and precision of the project. Automated liquid pipettors frequently use disposable pipette tips to reduce cross contamination of samples by inadvertently mixing residual fluid from one source with another.

The disposable pipette tips are typically stored in a rectilinear array, such as a pipette tip box, that is made accessible to the automated liquid pipettor. The automated liquid pipettor must load and unload the tips from or to these arrays in the pipette tip box. When loading less than the entire array of pipette tips, the automated liquid pipettor must load a set of the pipette tips from the pipette tip box, while the rest of the pipette tips remain in the pipette tip box.

### SUMMARY

The present disclosure relates to a pipetting instrument. In some embodiments, and by non-limiting example, the pipetting instrument performs a loading operation and an unloading operation, wherein the pipette tips are loaded from a pipette tip box onto a mandrel of the pipetting instrument, or the pipette tips are unloaded from the mandrel into the pipette tip box. In some embodiments, the mandrels are densely packed together to maximize the number of samples per unit area on a loading or unloading space. In some embodiments, the mandrels have a maximum diameter that couples to a maximum pipette tip diameter. Maximizing the pipette tip diameter is desirable because it maximizes the volume of sample that can be withdrawn per cycle into the pipette tips. Maximizing both the surface area of the mandrels and the number of mandrels per unit area can leave very little space between individual mandrels. Minimizing the space between mandrels may create difficulties in targeting desired pipette tips using the mandrels. Further, even if the desired pipette tips are loaded or unloaded using the mandrels, undesired pipette tips may be accidentally loaded from the pipette tip box along with the desired pipette tips. These undesired pipette tips may be loaded due to mechanical or electrostatic coupling to the mandrel or the desired pipette tips. Thus, it is desirable to create a pipetting device and method for loading or unloading the desired pipette tips from the pipette tip box while reliably unloading all undesired pipette tips from the mandrels.

In one example, a pipetting instrument for loading and dispensing a sample, comprises an automated liquid pipettor including a deck for supporting a pipette tip box comprising pipette tips, and mandrels for engaging the pipette tips and withdrawing at least some of the pipette tips from the pipette tip box; and a controller configured to control the automated liquid pipettor, the controller further configured to execute a pipette tip dislodging operation to dislodge any undesired pipette tips that are withdrawn from the pipette tip box using the mandrels.

In another example, a method for loading a set of pipette tips onto an automated liquid pipettor, the method comprises coupling desired pipette tips to mandrels by positioning the mandrels and engaging the pipette tips with the mandrels; lifting the mandrels to partially remove the desired pipette tips from a pipette tip box, and lifting at least one undesired pipette tip along with the desired pipette tips; moving the mandrels to dislodge the at least one undesired pipette tip from the mandrel, causing the at least one undesired pipette tip to return to the pipette tip box while the desired pipette tips remain coupled to the mandrels; and lifting the mandrels to fully remove the desired pipette tips from the pipette tip box.

In yet another example, a method for unloading one or more pipette tips from an automated liquid pipettor comprises positioning mandrels to engage and insert the pipette tips within a pipette tip box; activating a set of plungers to decouple the pipette tips from the mandrels and unload the pipette tips into the pipette tip box; positioning the mandrels to partially insert any pipette tips that remain coupled to the mandrels into the pipette tip box; and moving the mandrels and the pipette tips to decouple the pipette tips from the mandrels and unload the pipette tips into the pipette tip box.

A variety of additional aspects will be set forth in the description that follows. The aspects can relate to individual features and to combinations of features. It is to be understood that both the foregoing general description and the following detailed description are exemplary and explanatory only and are not restrictive of the broad inventive concepts upon which the examples disclosed herein are based.

### BRIEF DESCRIPTION OF THE DRAWINGS

The following drawings are illustrative of examples of the present disclosure and therefore do not limit the scope of the present disclosure. Examples of the present disclosure will hereinafter be described in conjunction with the appended drawings, wherein like numerals denote like elements.

FIG. 1 shows a block diagram of a pipetting instrument in accordance with the principles of the present disclosure, including an automated liquid pipetter and optionally including a pipette tip box.

FIG. 2A shows a transverse cross-sectional diagram of the pipetting instrument of FIG. 1 including mandrels, pipette tips, and a pipette tip box, wherein an undesired pipette tip is coupled to a mandrel and/or another pipette tip.

FIG. 2B shows a transverse cross-sectional diagram of the pipetting instrument of FIG. 1 including a mandrel, pipette tips, and a pipette tip box, wherein an undesired pipette tip is decoupled from the mandrel and/or another pipette tip and rests within the pipette tip box.

FIG. 3A shows a front view of example embodiments of the pipetting instrument of FIG. 1.

FIG. 3B shows a side view of example embodiments of the pipetting instrument of FIG. 1.

FIG. 4 shows a perspective view of a pod used in example embodiments of the pipetting instrument of FIG. 1.

FIG. 5 shows a top perspective view of the internal components of another embodiment of the pod used in example embodiments of the pipetting instrument of FIG. 1.

FIG. 6 shows a side perspective view of the internal components of another embodiment of the pod used in example embodiments of the pipetting instrument of FIG. 1.

FIG. 7 is a perspective view of the motion of the motorized gantry along the X-axis.

FIG. 8A shows a perspective view of the motion of the motorized gantry along the Y-axis.

FIG. 8B shows a perspective view of the motion of the motorized gantry along the Y-axis, wherein part of the motorized gantry is cutaway to show a Y-axis motor.

FIG. 9 shows a block diagram of basic hardware components in the pipetting instrument of FIG. 1 that illustrate the motion of the motorized gantry along the Z-axis.

FIG. 10 shows a block diagram of additional hardware components of the example pipetting instrument of FIG. 1.

FIG. 11 shows a perspective view of example embodiments of a pipette tip box.

FIG. 12 shows a perspective view of example embodiments of a pipette tip box, wherein the spacing of the pipette tips within the pipette tip box may slightly vary.

FIG. 13 shows a perspective view of a mandrel assembly used in example embodiments of the pipetting instrument of FIG. 1.

FIG. 14A shows a perspective view of an alternative mandrel assembly used in example embodiments of the pipetting instrument of FIG. 1.

FIG. 14B shows a perspective view of an alternative mandrel assembly used in example embodiments of the pipetting instrument of FIG. 1, wherein the mandrels are partially inserted into a pipette tip box or shuck plate.

FIG. 15 shows a segmented mandrel used in example embodiments of the pipetting instrument of FIG. 1.

FIG. 16A shows a transverse cross-sectional view of the mandrels inserted within pipette tips, wherein the mandrels include plungers for unloading the pipette tips when the plungers engage filters.

FIG. 16B shows a transverse cross-sectional view of the mandrels inserted within pipette tips of FIG. 16A, wherein the plungers are engaging the filters.

FIG. 17 shows an example computing device.

FIG. 18 shows a flowchart depicting the loading of a partial set, or desired set, of pipette tips in accordance with example embodiments of the pipetting instrument of FIG. 1.

FIG. 19A shows a transverse cross-sectional view of the mandrels, the pipette tip box, and the pipette tips depicting the first step of FIG. 18 where the mandrels approach and enter the pipette tips in the pipette tip box.

FIG. 19B shows a transverse cross-sectional view of the mandrels, the pipette tip box, and the pipette tips depicting the first step of FIG. 18 where the mandrels couple to the pipette tips in the pipette tip box.

FIG. 20A shows a transverse cross-sectional view of the mandrels, the pipette tip box, and the pipette tips depicting the second step of FIG. 18 where the mandrels are coupled to the pipette tips in the pipette tip box.

FIG. 20B shows a transverse cross-sectional view of the mandrels, the pipette tip box, and the pipette tips depicting the second step of FIG. 18 where the mandrels partially remove the pipette tips from the pipette tip box.

FIG. 21 shows a diagram depicting a coordinated movement the mandrels make to dislodge any undesired pipette tips from the mandrels or the desired pipette tips.

FIG. 22 shows a transverse cross-sectional view of the mandrels, the pipette tip box, and the pipette tips depicting the fourth step of FIG. 18 when the desired pipette tips have been fully removed from the pipette tip box and coupled to the mandrels.

FIG. 23 shows a flowchart depicting the unloading of pipette tips from the mandrels into the pipette tip box in accordance with example embodiments of the pipetting instrument of FIG. 1.

FIG. 24 shows a transverse cross-sectional view of the mandrels, the pipette tip box, and the pipette tips depicting the first step of FIG. 23 where the mandrels are positioned to engage and insert the pipette tips within the pipette tip box.

FIG. 25 shows a transverse cross-sectional view of the mandrels, the pipette tip box, and the pipette tips depicting the second step of FIG. 23, where plungers are activated on the mandrels to decouple the pipette tips from the mandrels and unload the pipette tips into the pipette tip box.

FIG. 26 shows a transverse cross-sectional view of the mandrels, the pipette tip box, and the pipette tips depicting the third step of FIG. 23, where the mandrels are positioned such that any pipette tips that remain coupled to the mandrels are partially inserted within the pipette tip box.

FIG. 27 shows a diagram depicting a coordinated movement of the mandrels to dislodge any undesired pipette tips from the mandrels depicting the fourth step of FIG. 23.

FIG. 28 shows a transverse cross-sectional view of the mandrels, the pipette tip box, and the pipette tips depicting the fifth step of FIG. 23, wherein the mandrels are removed from the pipette tip box and each of the pipette tips have been unloaded into the pipette tip box.

FIG. 29 shows a front view of the top of pipette tips having pipette tip features that may affect the process of loading or unloading desired pipette tips.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

Various examples will be described in detail with reference to the drawings, wherein like reference numerals represent like parts and assemblies throughout the several views.

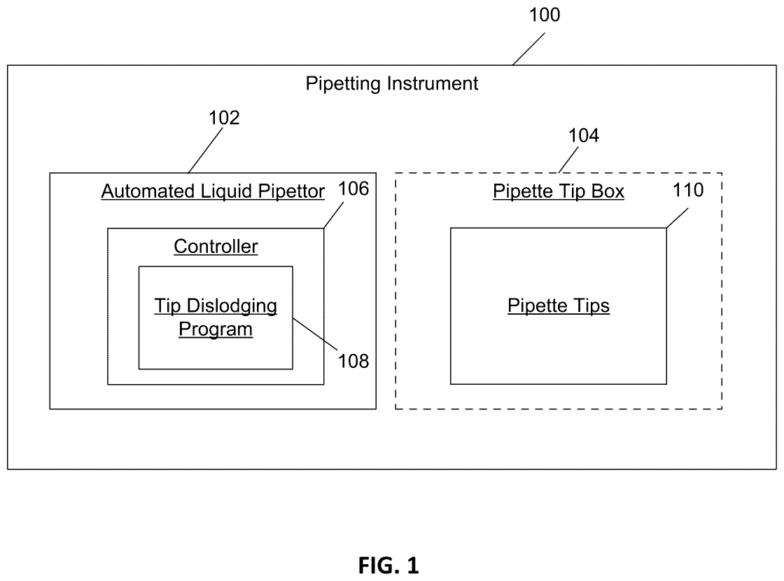

FIG. 1 is a block diagram of an example pipetting instrument 100. The example pipetting instrument 100 includes an automated liquid pipettor 102, a pipette tip box 104, and a controller 106. In some embodiments, the controller 106 is configured to perform a tip dislodging program 108.

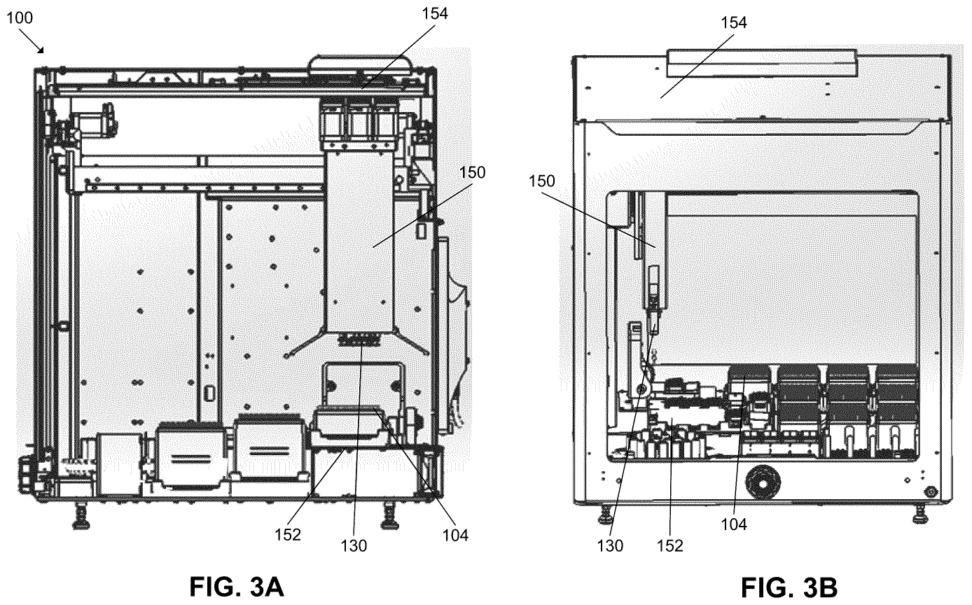

The pipetting instrument 100 is an instrument, such as a laboratory instrument, that performs pipetting operations. An example of a pipetting instrument 100 is a sample preparation instrument. An example of the sample preparation instrument is illustrated and described in further detail with reference to FIGS. 3A, 3B, 4, 5, 6, 9, and 22.

The automated liquid pipettor 102 is a system that performs automated pipetting functions. Examples of the automated liquid pipettor are illustrated and described in further detail with reference to FIGS. 3A and 3B.

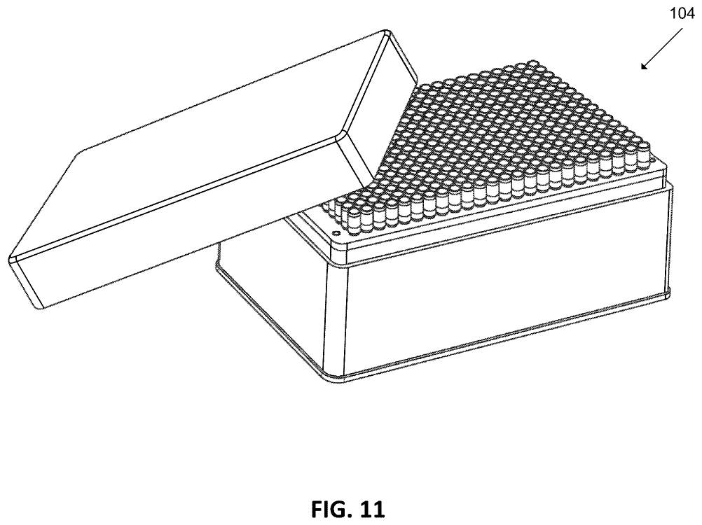

The pipette tip box 104 is a container configured to store pipette tips 110. In some embodiments, the pipette tip box 104 stores pipette tips 110 in a rectilinear fashion. Pipette tips 110 can be stored at a uniform distance from one another within the pipette tip box 104. In some embodiments, the pipette tip box 104 can hold 384 pipette tips 110 with a uniform spacing of 4.5 millimeters between each pipette tip 110. In some embodiments, the pipette tip box 104 can hold 96 pipette tips 110 with a uniform spacing of 9 millimeters between each pipette tip 110. In some embodiments, the positioning of the pipette tips 110 in the pipette tip box 104 can conform to industry standards for microplates, such as those developed by the Society for Laboratory Automation and Screening (SLAS), the American National Standards Institute (ANSI), or other industry standards. An example of a pipette tip box 104 is illustrated and described in further detail with reference to FIG. 11.

The controller 106 is configured to control the automated liquid pipettor 102. In some embodiments, the automated liquid pipettor 102 receives instructions from the controller 106 and retrieves and/or returns pipette tips 110 from and to the pipette tip box 104 to load or unload pipette tips 110 onto the automated liquid pipettor 102. The controller 106 is configured to perform a tip dislodging program 108 that removes any undesired pipette tips 132 from the automated liquid pipettor 102 as the automated liquid pipettor 102 is loading or unloading pipette tips 110 from the pipette tip box 104.

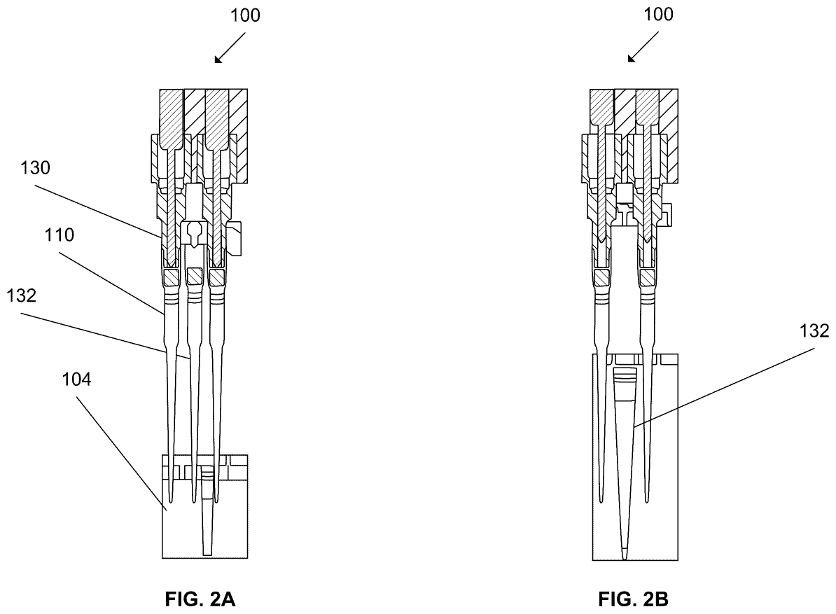

FIG. 2A shows a transverse cross-sectional diagram of the pipetting instrument 100 of FIG. 1 including mandrels 130, pipette tips 110, and a pipette tip box 104, wherein an undesired pipette tip 132 is coupled to the mandrels 130 and/or another pipette tip 110.

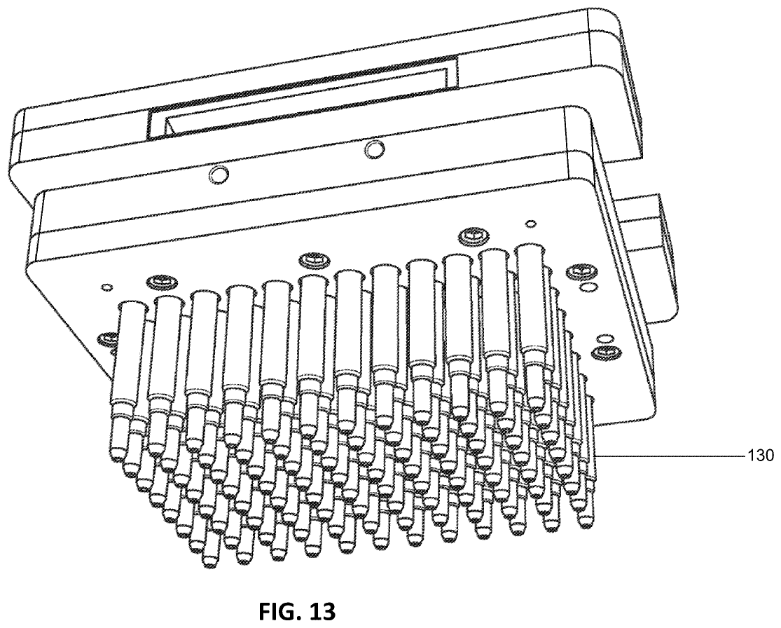

The mandrels 130 are connected to the pipetting instrument 100 and are configured to engage a pipette tip 110 by pressing the mandrel into the pipette tips 110. A bottom of the mandrels may be configured to attach to a top of the pipette tips 110 via a friction fit. Thus, pushing the mandrels 130 into the pipette tips 110 within the pipette tip box 104 may force the pipette tips 110 onto the mandrels 130 and provide an air-tight connection between the pipette tips 110 and the mandrels 130. An example of the mandrels 130 is illustrated and described in further detail with reference to FIG. 13.

The undesired pipette tip 132 is a pipette tip 110 that unintentionally remains coupled to a mandrel 130 or another pipette tip 110 after the mandrel is lifted from the pipette tip box 104. The undesired pipette tip 132 may be unintentionally lifted by the mandrel 130 due to mechanical or electrostatic coupling between the undesired pipette tip 132 and the mandrel 130, the undesired pipette tip 132 and a desired pipette tip 134, or the undesired pipette tip 132 and both the mandrel 130 and the desired pipette tip 134. In some embodiments, the controller 106 may control the automated liquid pipettor 102 and provide instructions to load every other pipette tip 110 from the pipette tip box 104. In these examples, a desired pipette tip 134 is defined by the controller as every other pipette tip 110 within the pipette tip box 104, while the undesired pipette tips 132 are defined as every pipette tip 110 that is not defined as a desired pipette tip 134. In FIG. 2A, the undesired pipette tip 132 is located between two desired pipette tips 134, where the undesired pipette tip 132 was unintentionally lifted from the pipette tip box 104.

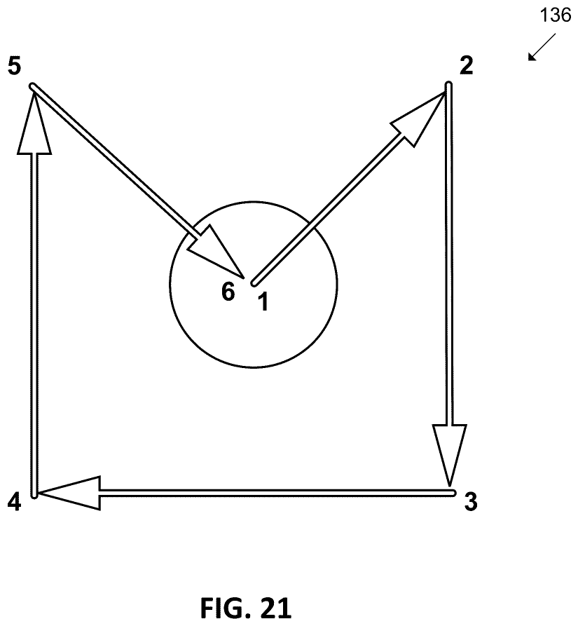

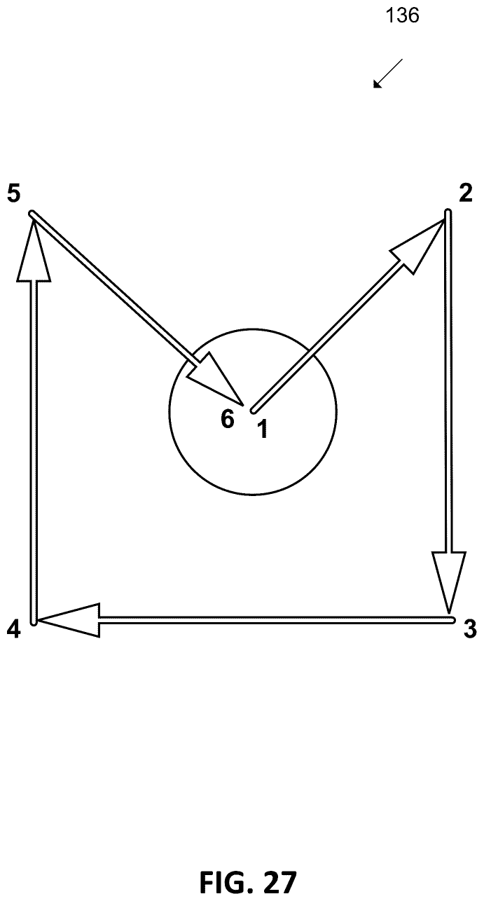

FIG. 2B shows a transverse cross-sectional diagram of the pipetting instrument 100 of FIG. 1 including the mandrels 130, pipette tips 110, a tray 111, and a pipette tip box 104, wherein an undesired pipette tip 132 is decoupled from the mandrel 130 and/or another pipette tip 110 and rests within the pipette tip box 104. The undesired pipette tip 132 can decouple from the mandrel 130 by inserting the undesired pipette tip 132 partially within the pipette tip box 104 and completing a coordinated movement 136 of the mandrels 130. The coordinated movement 136 of the mandrels 130 is a movement in which each mandrel 130 moves together synchronously to provide similar movements between each mandrel 130. The tray 111 is positioned above the pipette tip box 104 to guide the pipette tips 110 into the pipette tip box 104 as the mandrels 130 pass through the tray 111. An example of the coordinated movement 136 is illustrated and described in further detail with reference to FIGS. 21 and 27.

In some embodiments, the pipetting instrument 100 can include at least one sensor for identifying when an undesired pipette tip 132 is coupled to a mandrel 130 or a desired pipette tip 134. If any undesired pipette tips 132 are sensed, then the sensor may identify a population of mandrels 130 to perform a coordinated movement 136 to. If the sensor fails to sense any undesired pipette tips 132, then it may provide feedback to the controller 106 to forego the step of performing a coordinated movement 136.

FIG. 3A shows a front view of example embodiments of the pipetting instrument 100 of FIG. 1, which may include any combination of the various systems or components shown. For example, the pipetting instrument 100 may include one or more (or none) each of a pod 150, mandrels 130, a pipette tip box 104, a deck 152 and a motorized gantry 154. An overview of these various components of the pipetting instrument 100 is provided below.

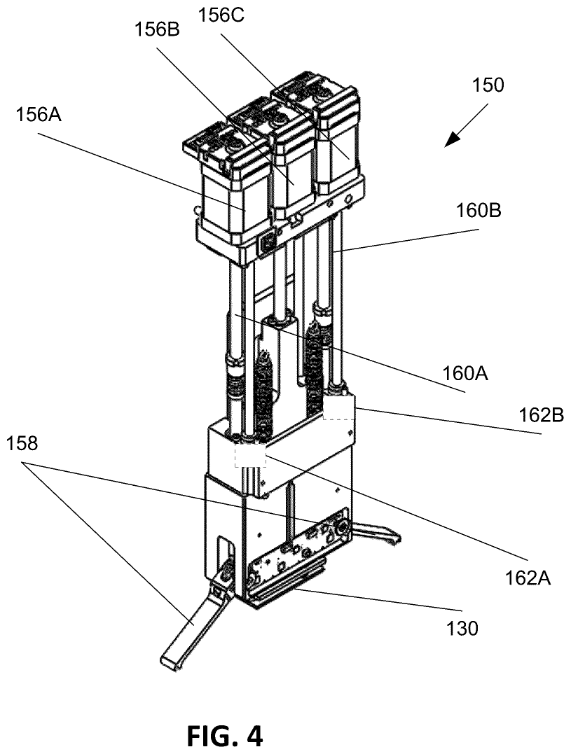

In some embodiments, the pipetting instrument 100 may include a motorized gantry 154. In some of such embodiments, the motorized gantry 154 may be movable along one or more axes. For example, the motorized gantry 154 may be laterally slideable along the length of the pipetting instrument 100. In some embodiments, the pipetting instrument 100 may include a pod 150 that is mechanically coupled to the motorized gantry 154. As shown in the figure, the pod 150 may have an elongate housing in the vertical axis that is held upright by the motorized gantry 154. The bottom of the pod 150, which is shown in more detail in FIG. 4, may include mandrels 130 that are configured to interface and/or connect to one or more pipette tips 110 in a pipette tip box 104. In certain embodiments, the pod 150 may be moveable along the motorized gantry 154 in one or more axes. For example, as shown in the figure, the pod 150 may be laterally slideable along the length of the motorized gantry 154. Furthermore, in some embodiments, the pod 150 may be vertically slideable relative to the motorized gantry 154 such that the bottom of the pod 150 can be positioned higher or lower. Accordingly, the bottom of the pod 150 may be re-positioned with precise, 3-axis movement by adjusting a combination of: the height of the pod 150 relative to the motorized gantry 154 (e.g., the Z-axis), the lateral position of the pod 150 along the motorized gantry 154 (e.g., the Y-axis 182), and the lateral position of the motorized gantry 154 along the length of the pipetting instrument 100 (e.g., the X-axis 180). In this figure, the lateral motion of the motorized gantry 154 illustrates motion along the Y-axis 182.

In some embodiments, the pod 150 may be a multichannel pod which is configured for interfacing with, and connecting to, multiple pipette tips 110 that can be simultaneously used to perform pipetting operations. In some embodiments, the pod 150 may contain various components that allow for various pipetting and fluid-handling operations to be performed using attached pipette tips 110.

The deck 152 may be located within the pipetting instrument 100, wherein the deck is used to support various lab materials associated with the pipetting instrument 100. In the figure, the deck 152 supports a pipette tip box 104 positioned to engage with the mandrels 130 to perform a pipetting operation.

FIG. 3B shows a front view of example embodiments of the pipetting instrument 100 of FIG. 1, which may include any combination of the various systems or components shown. In this figure, the lateral motion of the motorized gantry 154 illustrates motion along the X-axis 180.

FIG. 4 shows a front view of a pod 150 used in example embodiments of the pipetting instrument of FIG. 1. In some embodiments, the pod 150 may include mandrels 130 at the bottom of the pod 150. Each mandrel 130 may be configured to couple to a pipette tip 110, and each mandrel 130 may have an elongate channel (not shown) that spans the vertical length of the mandrel 130. This elongate channel may allow each mandrel 130 to facilitate the performance of pipetting operations on an attached pipette head. For example, the elongate channel may be used to create varying degrees of pressure within an attached pipette tip, allowing for liquid to be sucked into, or expelled from, the bottom of that pipette tip 110.

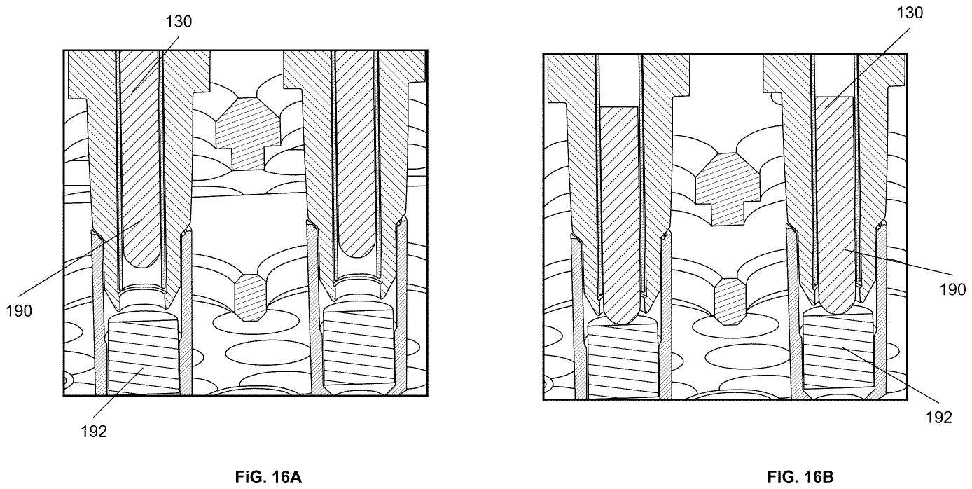

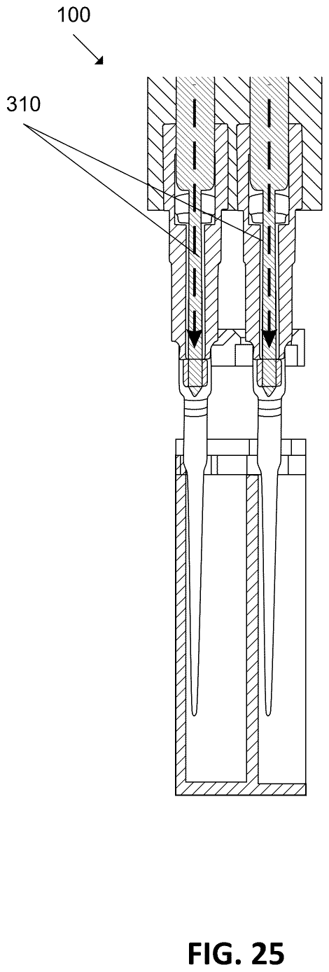

The pod 150 includes pod motors 156. In example embodiments of the pod 150, the pod 150 may include three pod motors 156 at the top of the pod 150. The pod motors 156 may control plungers 190 that remove pipette tips 110 from the mandrels 130 along a plunger pathway 312. An example of the plungers 190 and the plunger pathway 312 are illustrated and described in further detail with reference to FIGS. 16 and 25. Furthermore, the pod motors 156 may control the position of the mandrels 130 along a Z-axis 184, which is illustrated and described in further detail with reference to FIGS. 4-6.

Furthermore, the pod 150 may also include arms 158 for grasping objects below the pod 150. In some embodiments, the arms 158 may extend downward to grasp labware below the pod 150 to stabilize the labware and allow mandrels 130 connected to the pod 150 to engage with the labware. In some embodiments, the arms 158 may be controlled by at least one of the pod motors 156, wherein the pod motors are configured to engage and disengage the arms 158 to grasp or release the labware.

Further yet, the pod 150 includes three pod motors 156A, 156B, and 156C. The pod motors 156A and 156 C are mechanically coupled to two lead screws 160A and 160B, respectively. The lead screws 160A and 160B are coupled to two nuts 162A and 162B, respectively, that are fixed to a bracket and allow for the pod 150 to move along the Z-axis 184 as the pod motors 156A and 156C turn the two lead screws 160A and 160B. In this figure, a pod motor 156B can be used to operate plungers 190 stored within mandrels 130 that are attached to the pod 150.

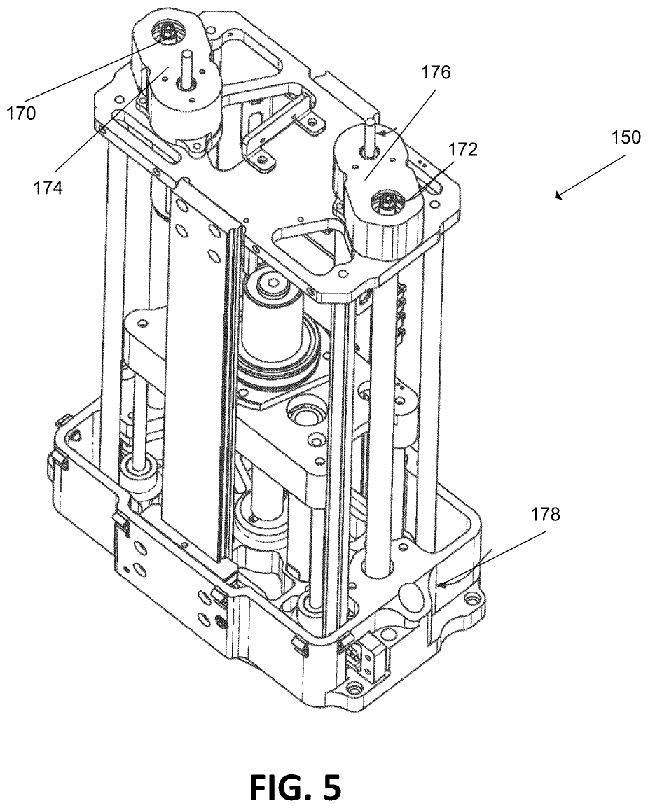

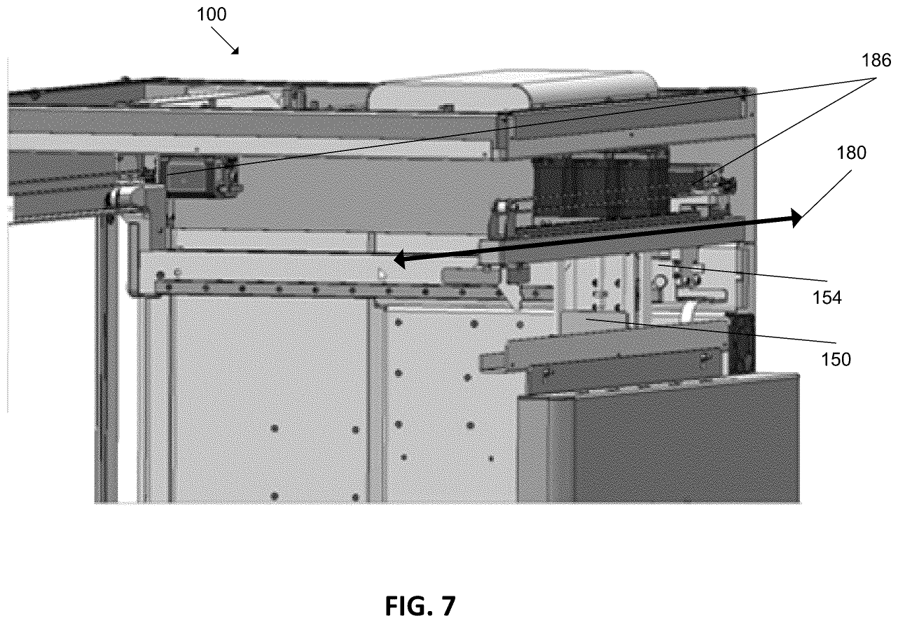

FIG. 5 shows a top perspective view of the internal components of another embodiment of the pod 150 used in example embodiments of the pipetting instrument 100 of FIG. 1. The pod 150 includes a first lead screw 170, a second lead screw 172, a first Z-axis motor 174, a second Z-axis motor 176, and a mounting plate 178. More specifically, FIG. 5 illustrates how the lead screws, such as the first lead screw 170 and the second lead screw 172, may be turned in various embodiments of the pod 150. It is contemplated that any method and configuration may be used for turning the lead screws, and not only through the use of motors mechanically coupled to the lead screws. Furthermore, there may be any number of motors that are mechanically coupled to any number of lead screws. Examples of the motors are illustrated and described in further detail with reference to FIGS. 7-9.

As shown in the figure, each individual lead screw is mechanically coupled to an independent motor. For instance, the top of the first lead screw 170 may be mechanically coupled to a first Z-axis motor 174. In some embodiments, the first Z-axis motor 174 may be within an enclosure and mechanically coupled to the first lead screw 170 by a pulley and belt, both of which may also be housed within the pod 150. The operation of the first Z-axis motor 174 may be used to turn the first lead screw 170 clockwise and counterclockwise. The top of the second lead screw 172 may be mechanically coupled to a second Z-axis motor 176. In some embodiments, the second Z-axis motor 176 may also be mechanically coupled to the second lead screw 172 by a pulley and belt, both of which may also be housed within the pod 150. The operation of the second Z-axis motor 176 may be used to turn the second lead screw 172 clockwise and counterclockwise. Both lead screws may span the vertical dimensions of the pod 150 and may be anchored at both the top of the pod 150 and the bottom of the pod 150.

Thus, in various embodiments, each lead screw may be mechanically coupled to an independent motor that drives it. This configuration may also provide numerous advantages for allowing for the loading of a partial rack of pipette tips 110, as opposed to the loading of all the pipette tips 110 in the pipette tip box 104. In a typical scenario where a full pipette tip box 104 is loaded, a symmetrical downward force can used. For instance, the workstation may re-position the bottom of the pod to be centered over the full tip tray.

The mounting plate 178 is coupled to the first lead screw 170 and the second lead screw and is driven along the Z-axis 184 along the lead screws by the first Z-axis motor 174 and the second Z-axis motor 176. In some embodiments, the mounting plate 178 moves up and down the lead screws along the Z-axis 184 to position mandrels 130 and engage the mandrels 130 with pipette tips 110 stored within the pipette tip box.

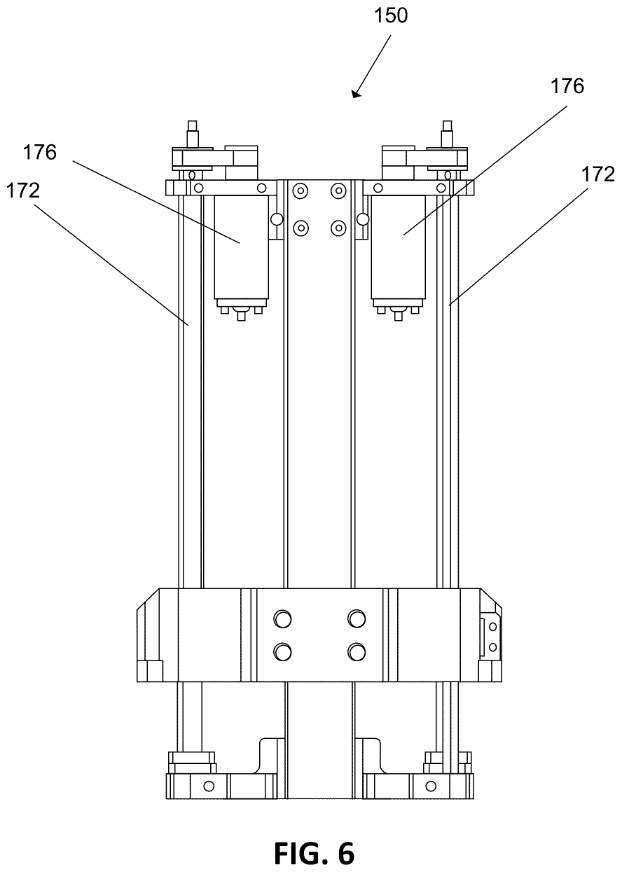

FIG. 6 shows a side perspective view of the internal components of another embodiment of the pod 150 used in example embodiments of the pipetting instrument of FIG. 1. This figure illustrates a view of the internal components of a pod 150 utilizing the first lead screw 170 and the second lead screw 172 according to one example embodiment wherein the first lead screw 170 is mechanically coupled to the first Z-axis motor 174 and the second lead screw 172 is mechanically coupled to the second motor as described above to provide for vertical motion of the mounting plate 178 along the Z-axis 184. This motion allows the pod 150 to be positioned such that it engages with a pipette tip box 104 to withdraw pipette tips 110 from the pipette tip box 104.

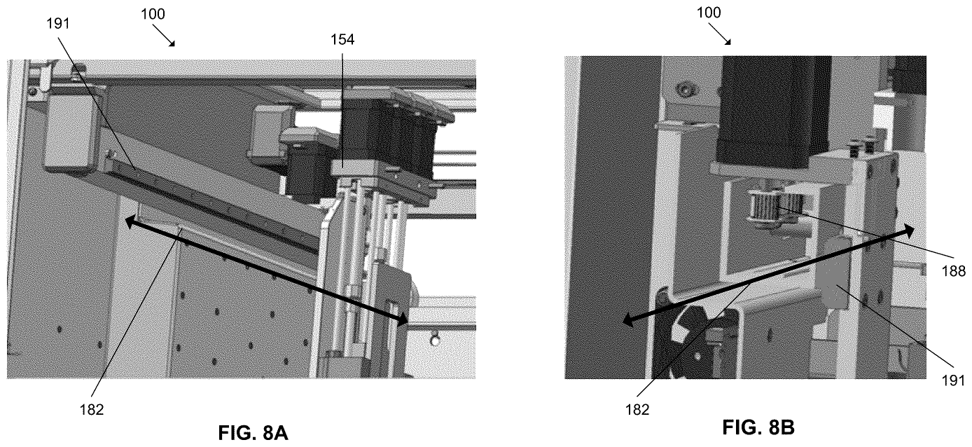

FIG. 7 is a perspective view of the motion of the motorized gantry 154 along the X-axis 180. The pipetting instrument 100 includes the motorized gantry 154 that is configured to move the pod 150 along the X-axis 180 and the Y-axis 182. The motion of the motorized gantry 154 along the Y-axis 182 is illustrated and described in further detail with reference to FIGS. 8A and 8B.

Motion of the motorized gantry 154 along the X-axis 180 is driven by X-axis motors 186. The X-axis motors 186 are configured to each drive a timing pulley and timing belt to move the motorized gantry 154 along the X-axis 180. In some embodiments, the X-axis motors 186 may drive the motorized gantry 154 along lead screws.

FIG. 8A shows a perspective view of the motion of the motorized gantry along the Y-axis 182. The pipetting instrument 100 includes the motorized gantry 154 that is configured to move the pod 150 along the X-axis 180 and the Y-axis 182. The motorized gantry 154 moves along the Y-Axis 182 by gliding along a bridge 191. The bridge 191 serves as a linear guide to guide the motorized gantry along the Y-Axis 182.

FIG. 8B shows a perspective view of the motion of the motorized gantry along the Y-axis, wherein part of the motorized gantry is cutaway to show a Y-axis motor. In this figure, portions of the pipetting instrument 100 are cutaway to reveal the Y-axis motor 188. The Y-axis motor 188 drives the motorized gantry 154 along the Y-axis 182 by driving a timing pulley and timing belt. In some embodiments, the Y-axis motors 188 may drive the motorized gantry 154 along lead screws.

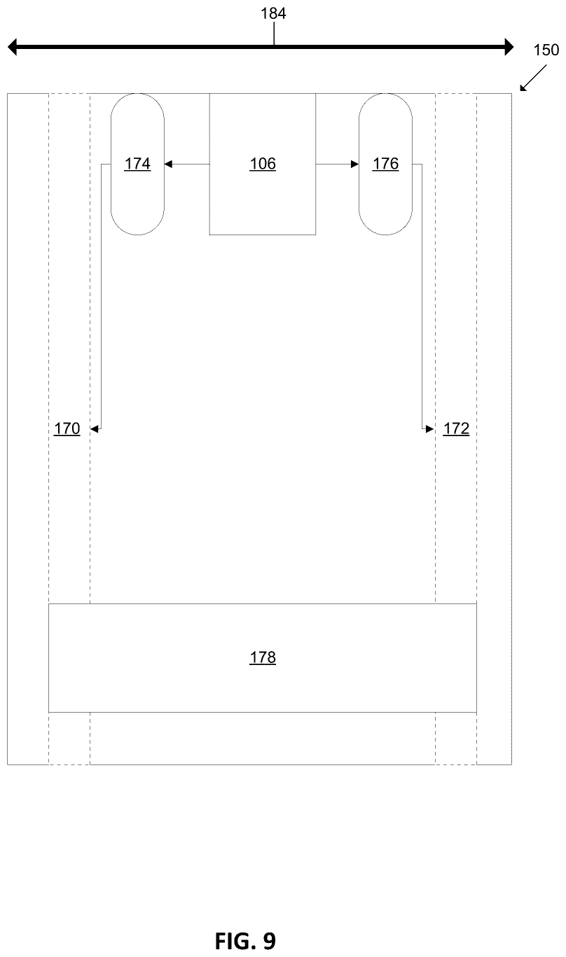

FIG. 9 shows a block diagram of basic hardware components in the pipetting instrument of FIG. 1 that illustrate the motion of the motorized gantry along the Z-axis 184. The block diagram includes the controller 106, the first lead screw 170, the second lead screw 172, the first Z-axis motor 174, the second Z-axis motor 176, and the mounting plate 178. Specifically, this block diagram further illustrates the movement of the mounting plate 178 along the Z-axis 184.

The mounting plate 178 is configured to move along the first lead screw and second lead screw as follows. The controller 106 controls the first Z-axis motor 174 and the second Z-axis motor 176 to rotate the drive the lead screws, which then moves the mounting plate in the Z-axis 184.

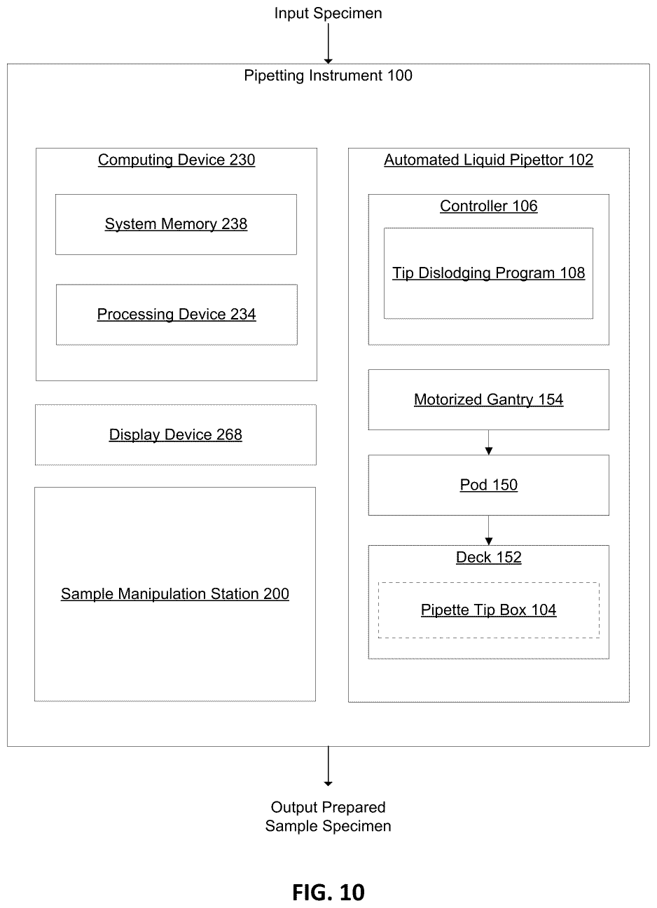

FIG. 10 shows a block diagram of additional hardware components of the example pipetting instrument of FIG. 1. The block diagram illustrates the pipetting instrument 100 configured to input a specimen and output a prepared sample. The pipetting instrument 100 includes a computing device 230 further comprising a system memory 238 and processing device 232, a display device 268, sample manipulation station 200, an automated liquid pipettor 102 including a controller 106, which further includes a tip dislodging program, a motorized gantry 154, a pod 150, and a deck 152, wherein the pipette tip box may be stored on the deck within the pipetting instrument 100, as indicated by the dashed outline.

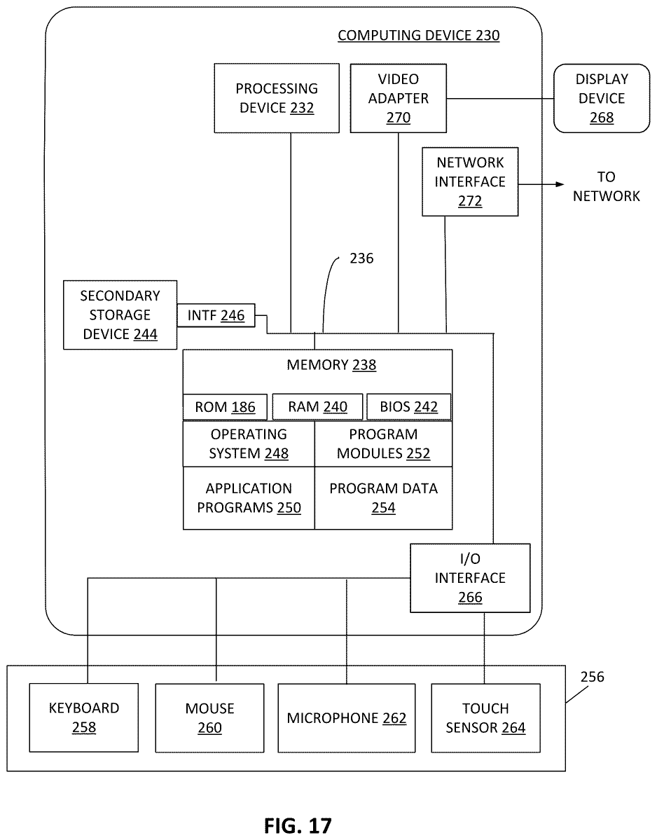

Examples of the computing device 230, the system memory 238, the processing device 232, and the display device 268 are illustrated and described in further detail with reference to FIG. 17. The computing device 230 can be used to execute the operating system, application programs, and software modules (including the software engines) described herein. The display device 268 may communicate with an operator and provide feedback from the computing device 230. The computing device may provide input to, or receive input from, the automated liquid pipettor 102.

Samples loaded to the automated liquid pipettor 102 may be manipulated at a sample manipulation station 200 configured to manipulate an input specimen to output a prepared sample. The sample manipulation station 200 can complete a number of different tasks to prepare a sample, including pipetting, mixing, heating, or otherwise manipulating the sample to prepare an output sample.

FIG. 11 shows a perspective view of example embodiments of a pipette tip box 104. As shown in the figure, the pipette tips 110 are held upright in the pipette tip box 104 in a 16×24 configuration, for a total of 384 pipette tips. These pipette tips would be used with a corresponding set of mandrels 130 having the same 16×24 configuration to allow pipetting operations to be performed with up to 384 pipette tips. The pipette tip box 104 may be supported by the deck 152 within the pipetting instrument 100. In some embodiments, the pipette tip box 104 may hold the pipette tips 110 upright in an 8×12 configuration, for a total of 96 pipette tips 110. These pipette tips 110 would be used with a corresponding set of mandrels 130 having the same 8 x 12 configuration to allow pipetting operations to be performed with up to 96 pipette tips 110.

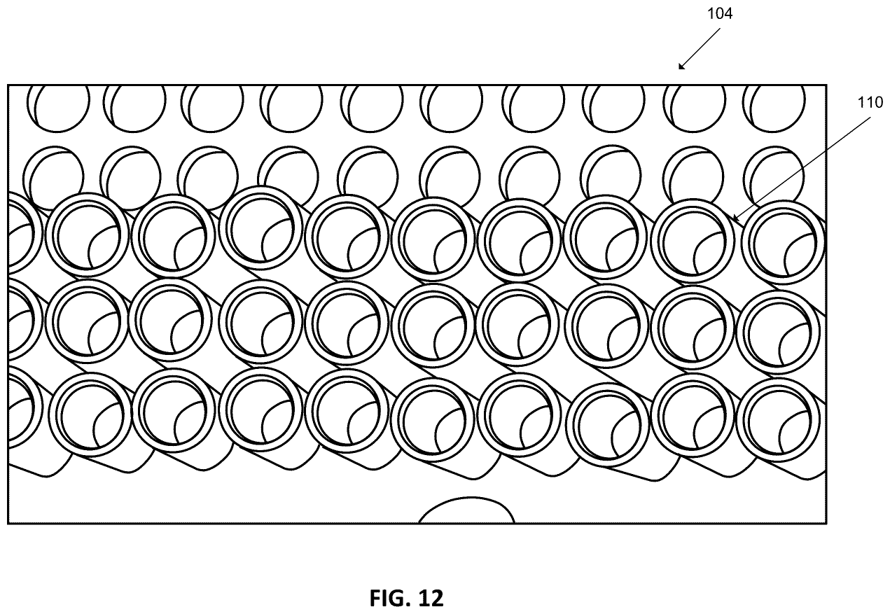

FIG. 12 shows a perspective view of example embodiments of a pipette tip box 104, wherein the spacing of the pipette tips 110 within the pipette tip box 104 may slightly vary. In this figure, the pipette tips 110 may touch in some locations or be further spaced apart than an average spacing between pipette tips 110. Spacing between pipette tips 110 that is less than an average spacing between the pipette tips 110 may further contribute to unwanted loading of an undesired pipette tip 132 onto a mandrel 130 or a desired pipette tip 134.

FIG. 13 shows a perspective view of a mandrel assembly including mandrels 130 used in example embodiments of the pipetting instrument of FIG. 1. As shown in the figure, the mandrels 130 are in an 8×12 configuration, for a total of 96 mandrels. Thus, the mandrels 130 can be simultaneously attached to 96 pipette tips 110. In some embodiments, the mandrels 130 may be in a 16×24 configuration, for a total of 384 mandrels 130. In some embodiments, each mandrel 130 may be generally cylindrical with an elongate channel that spans the vertical length of the mandrel. This elongate channel may allow each mandrel 130 to facilitate the performance of pipetting operations on an attached pipette head. For example, the elongate channel may be used to create varying degrees of pressure within an attached pipette tip 110, allowing for liquid to be sucked into, or expelled from, the bottom of that pipette tip 110. In some embodiments, each mandrel 130 may be tapered towards the bottom end or have features at the bottom end that facilitate an air-tight friction fit with the top of a corresponding pipette tip 110.

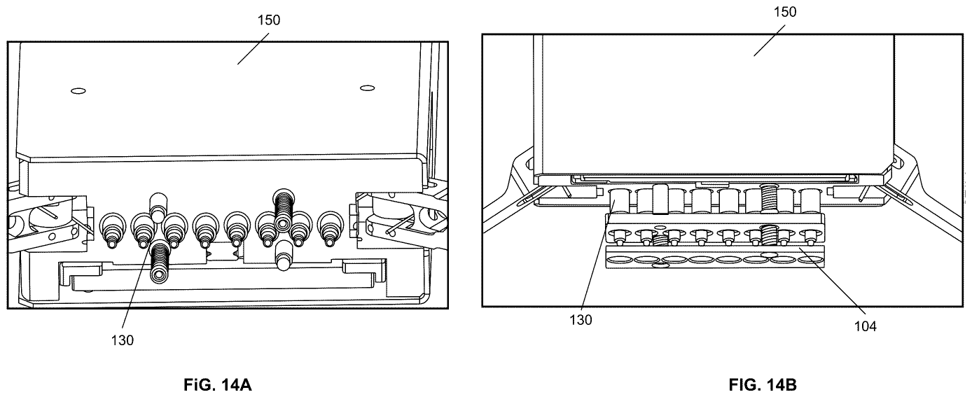

FIG. 14A shows a perspective view of an alternative mandrel assembly including mandrels 130 used in example embodiments of the pipetting instrument of FIG. 1. As shown in the figure, the mandrels 130 are in a 1×8 configuration, for a total of 8 mandrels 130. The mandrels 130 may couple to the pod 150.

FIG. 14B shows a perspective view of an alternative mandrel assembly used in example embodiments of the pipetting instrument of FIG. 1, wherein the mandrels are partially inserted into a pipette tip box 104 or shuck plate. As shown in the figure, the mandrels 130 are in a 1×8 configuration, for a total of 8 mandrels 130. The pod 150 may be positioned such that the mandrels 130 are at least partially inserted into a pipette tip box 104 to engage the pipette tips 110. The pipette tip box may be stored on a deck 152.

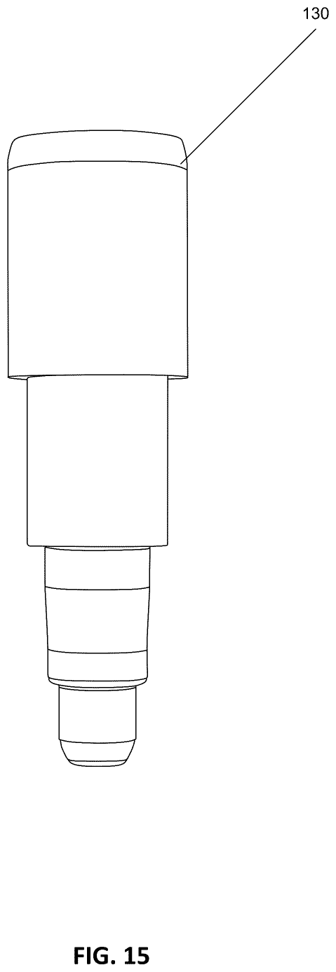

FIG. 15 shows a segmented mandrel 130 used in example embodiments of the pipetting instrument of FIG. 1. The mandrel 130 may be segmented such that it includes sections of varying diameters. In some embodiments, the varying diameters may correspond to diameters of pipette tips 110 stored in the pipette tip box 104. In some embodiments, the varying diameters may correspond to diameters of pipette tips 110 that are standardized by organizations that regulate pipetting microplates. In some embodiments, these standards may be regulated by the Society for Laboratory Automation and Screening (SLAS). In some embodiments, a segment of the mandrel 130 may correspond to a diameter of a pipette tip 110 that is stored in a pipette tip box 104 having 384 pipette tips 110 as shown in FIG. 11. In some embodiments, a segment of the mandrel 130 may correspond to a diameter of a pipette tip 110 that is stored in a pipette tip box 104 having 96 pipette tips 110 as shown in the mandrel assembly of FIG. 13 having 96 mandrels 130. In some embodiments, the mandrels 130 may include stainless steel. In some embodiments, the mandrels 130 may be installed on the automated liquid pipettor 102 using an interference fit.

FIG. 16A is a transverse cross-sectional view of the mandrels 130 inserted within the pipette tips 110, wherein the mandrels 130 include plungers 190 for unloading the pipette tips 110 when the plungers 190 engage filters 192. In some embodiments, the plungers 190 are driven by the pod motors 156. The plungers 190 unload the pipette tips 110 by exerting a downward force toward the bottom of the mandrel 130 along a plunger pathway 312. The plunger pathway 312 is described and illustrated in further detail with reference to FIG. 25. As the plungers 190 are moved along the plunger pathway 312, the plungers 190 may contact the filters 192, wherein the filters 192 exert an equal and opposite force on the mandrels 130 in an upward force toward the top of the mandrels 130. These forces dislodge the pipette tips 110 from the mandrels 130.

The filters 192 are configured to provide a barrier between the mandrels 130 and fluid that is drawn from a sample using the pipette tips 110. The filters 192 are configured to allow air to flow through the filter while obstructing liquids, such as samples that are drawn into pipette tips 110.

FIG. 16B is a transverse cross-sectional view of the mandrels 130 inserted within pipette tips 110 of FIG. 16A, wherein the plungers 190 are engaging the filters 192. In this figure, the plungers 190 are engaging the filters 192 to dislodge the pipette tips 110 from the mandrels 130.

FIG. 17 shows an exemplary architecture of a computing device that can be used to implement aspects of the present disclosure, including any of the plurality of computing devices 230, controller 106, and the like. The computing device illustrated in FIG. 17 can be used to execute the operating system, application programs, software modules (including the software engines, and including the tip dislodging program 108) described herein.

The computing device 230 includes, in some embodiments, at least one processing device 232, such as a central processing unit (CPU). A variety of processing devices are available from a variety of manufacturers, for example, Intel or Advanced Micro Devices. In this example, the computing device 230 also includes a system memory 234, and a system bus 236 that couples various system components including the system memory 234 to the processing device 232. The system bus 236 is one of any number of types of bus structures including a memory bus, or memory controller; a peripheral bus; and a local bus using any of a variety of bus architectures.

Examples of computing devices suitable for the computing device 230 include a server computer, a desktop computer, a laptop computer, a tablet computer, a mobile computing device (such as a smart phone, an iPod® or iPad® mobile digital device, or other mobile devices), or other devices configured to process digital instructions.

The system memory 234 includes read only memory 238 and random access memory 240. A basic input/output system 242 containing the basic routines that act to transfer information within computing device 230, such as during start up, is typically stored in the read only memory 238.

The computing device 230 also includes a secondary storage device 244 in some embodiments, such as a hard disk drive, for storing digital data. The secondary storage device 244 is connected to the system bus 236 by a secondary storage interface 246. The secondary storage devices 244 and their associated computer readable media provide nonvolatile storage of computer readable instructions (including application programs and program modules), data structures, and other data for the computing device 230.

Although the exemplary environment described herein employs a hard disk drive as a secondary storage device, other types of computer readable storage media are used in other embodiments. Examples of these other types of computer readable storage media include magnetic cassettes, flash memory cards, digital video disks, Bernoulli cartridges, compact disc read only memories, digital versatile disk read only memories, random access memories, or read only memories. Some embodiments include non-transitory media. Additionally, such computer readable storage media can include local storage or cloud-based storage.

A number of program modules can be stored in secondary storage device 244 or memory 234, including an operating system 248, one or more application programs 250, other program modules 252 (such as the software engines described herein), and program data 254. The computing device 230 can utilize any suitable operating system, such as Microsoft Windows™, Google Chrome™, Apple OS, and any other operating system suitable for a computing device.

In some embodiments, a user provides inputs to the computing device 230 through one or more input devices 256. Examples of input devices 256 include a keyboard 258, mouse 260, microphone 262, and touch sensor 264 (such as a touchpad or touch sensitive display). Other embodiments include other input devices 256. The input devices are often connected to the processing device 232 through an input/output interface 266 that is coupled to the system bus 236. These input devices 256 can be connected by any number of input/output interfaces, such as a parallel port, serial port, game port, or a universal serial bus. Wireless communication between input devices and the interface 266 is possible as well, and includes infrared, BLUETOOTH® wireless technology, 802.11a/b/g/n, cellular, or other radio frequency communication systems in some possible embodiments.

In this example embodiment, a display device 268, such as a monitor, liquid crystal display device, projector, or touch sensitive display device, is also connected to the system bus 236 via an interface, such as a video adapter 270. In addition to the display device 268, the computing device 230 can include various other peripheral devices (not shown), such as speakers or a printer.

When used in a local area networking environment or a wide area networking environment (such as the Internet), the computing device 230 is typically connected to the network through a network interface 272, such as an Ethernet interface. Other possible embodiments use other communication devices. For example, some embodiments of the computing device 230 include a modem for communicating across the network.

The computing device 230 typically includes at least some form of computer readable media. Computer readable media includes any available media that can be accessed by the computing device 230. By way of example, computer readable media include computer readable storage media and computer readable communication media.

Computer readable storage media includes volatile and nonvolatile, removable and non-removable media implemented in any device configured to store information such as computer readable instructions, data structures, program modules or other data. Computer readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the computing device 230. Computer readable storage media does not include computer readable communication media.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

The computing device illustrated in FIG. 17 is also an example of programmable electronics, which may include one or more such computing devices, and when multiple computing devices are included, such computing devices can be coupled together with a suitable data communication network so as to collectively perform the various functions, methods, or operations disclosed herein.

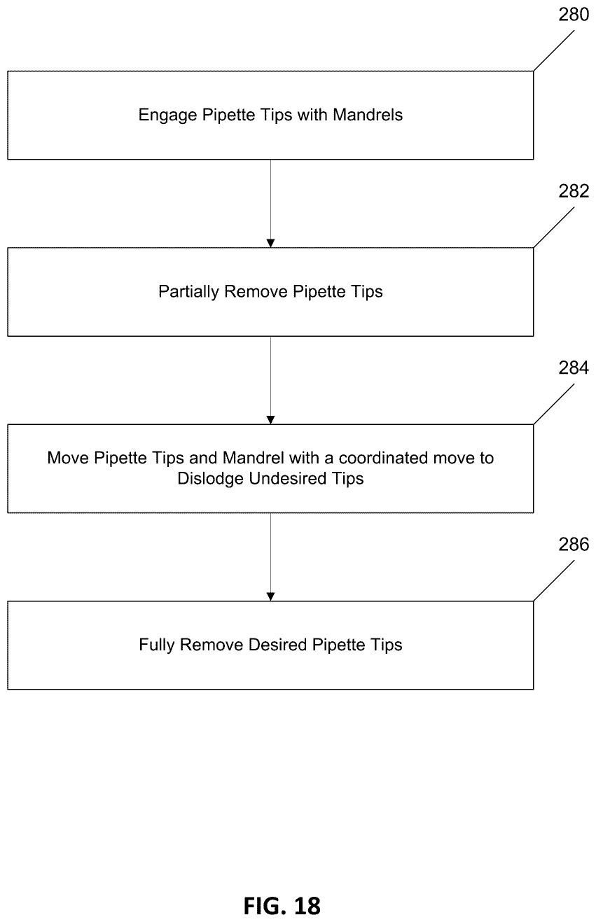

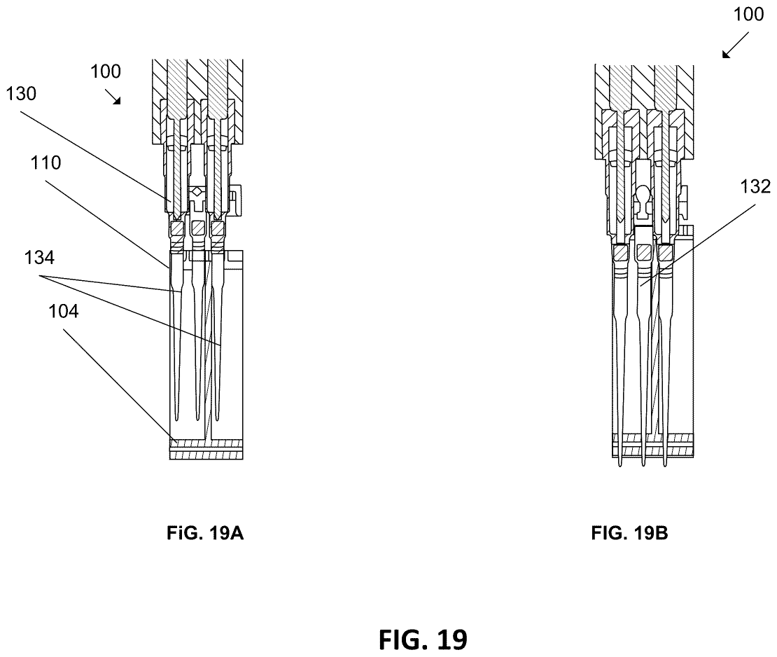

FIG. 18 shows a flowchart depicting the loading of a desired pipette tips 134 in accordance with example embodiments of the pipetting instrument of FIG. 1. This figure includes a first step 280 of engaging the pipette tips 110 with mandrels 130, a second step 282 of partially removing the pipette tips 110 from the pipette tip box 104 by lifting the pipette tips 110 with the mandrels 130, a third step 284 of moving the pipette tips 110 and the mandrel 130 with a coordinated movement 136 to dislodge the undesired pipette tips 132, and a fourth step 286 of fully removing the desired pipette tips 134 from the pipette tip box 104 using the mandrels 130. Examples of the each of the first step, the second step, the third step, and the fourth step are illustrated and described in further detail with reference to FIGS. 19, 20, 21, and 22, respectively.

FIG. 19A shows a transverse cross-sectional view of a pipetting instrument 100 including mandrels 130, the pipette tip box 104, and the pipette tips 110 depicting the first step 280 of FIG. 18, where the mandrels 130 approach and enter the pipette tips 110 in the pipette tip box 104. In some embodiments, the mandrels 130 may only approach and enter a partial subset of the pipette tips 110, where the targeted partial subset is the desired pipette tips 134 and any non-targeted subset is the undesired pipette tips 132. In some embodiments, the desired pipette tips 134 may include an organized pattern of pipette tips 110, such as every other pipette tip 110. This would mean every other pipette tip 110 is a desired pipette tip 134 and the remaining pipette tips 110 are undesired pipette tips 132. As shown in the figure, the outer pipette tips are desired pipette tips 134 that are targeted by the mandrels 130 and the inner pipette tip is an undesired pipette tip 132 that is not targeted by the mandrels 130. In some embodiments, the mandrels may approach and enter desired pipette tips 134 by moving the pod 150 along the Z-axis 184. Examples illustrating the movement of the pod 150 along the Z-axis 184 are illustrated and described in further detail with reference to FIGS. 5, 6, and 9.

FIG. 19B shows a transverse cross-sectional view of a of a pipetting instrument 100 including mandrels 130, the pipette tip box 104, and the pipette tips 110 depicting the first step 280 of FIG. 18 where the mandrel 130 couples to the pipette tips 110 in the pipette tip box 104. In this figure, and in some embodiments, the mandrels 130 are targeting the outer pipette tips 110. Thus, the outer pipette tips 110 are desired pipette tips 134 and the inner pipette tip 110 is an undesired pipette tip 132. The mandrels 130 couple to the desired pipette tips 134 by press the mandrels 130 into the desired pipette tips 134 to create an air-tight, interference fit. Examples illustrating the air-tight, interference fit between the mandrels 130 and the desired pipette tips 134 are illustrated and described in further detail with reference to FIG. 2.

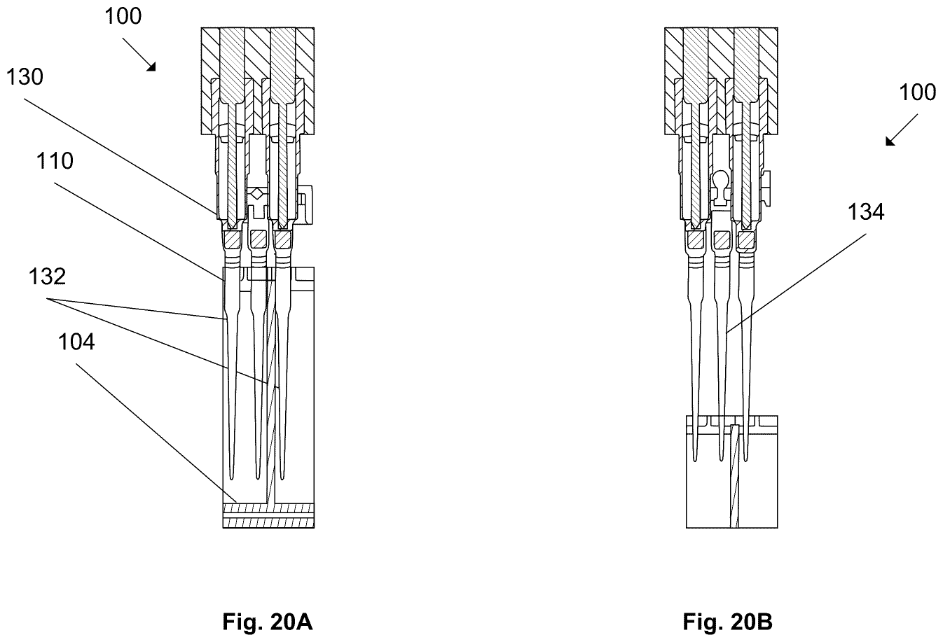

FIG. 20A shows a transverse cross-sectional view of mandrels 130, the pipette tip box 104, and the pipette tips 110 depicting the second step 282 of FIG. 18 where the mandrels 130 are coupled to the pipette tips 110 in the pipette tip box 104. The step of coupling the mandrels 130 to the pipette tips 110 in the pipette tip box 104 with an air-tight, friction fit between the mandrels 130 and the desired pipette tips 134 as illustrated and described in further detail in FIGS. 2, 10, and 13B. In this figure, and in some embodiments, the desired pipette tips 134 are the outer pipette tips 110 and the undesired pipette tips 132 are illustrated by the inner pipette tip 110.

FIG. 20B shows a transverse cross-sectional view of the mandrels 130, the pipette tip box 104, and the pipette tips 110 depicting the second step 282 of FIG. 18 where the mandrels 130 partially remove the pipette tips 110 from the pipette tip box 104.

In this figure, and in some embodiments, the desired pipette tips 134 are the outer pipette tips 110 and the undesired pipette tips 132 are illustrated by the inner pipette tip 110. In some embodiments, the mandrels 130 may accidentally remove an undesired pipette tip 132 from the pipette tip box 104 as an undesired pipette tip 132 couples to a mandrel 130, a desired pipette tip 134, or both. In some embodiments, the undesired pipette tip may couple to the mandrel 130, the desired pipette tip 134, or both by mechanical or electrostatic coupling. To dislodge the undesired pipette tips 132 from the mandrels 130, the mandrels 130 lift the pipette tips 110 from the pipette tip box 104 while keeping the pipette tips 110 partially inserted into the pipette tip box 104 prior to performing a coordinated movement 136 to dislodge any undesired pipette tips 132 from the mandrels 130 and/or desired pipette tips 134. Examples illustrating the coordinated movement 136 of the mandrels 130 are illustrated and described in further detail with reference to FIGS. 21 and 27.

FIG. 21 shows a diagram depicting a coordinated movement 136 the mandrels 130 make to dislodge any undesired pipette tips 132 from the mandrels 130 or the desired pipette tips 134.

The coordinated movement 136 includes moving each of the mandrels in a similar motion to dislodge any undesired pipette tips 132 from the desired pipette tips 134 or the mandrels 130. In some embodiments, the coordinated movement 136 can comprise moving the mandrels 130 in a motion comprising a horizontal and/or a vertical component within the pipette tip box 104 to press the pipette tips 110 against the pipette tip box 104. Interference between the undesired pipette tips 132 and the pipette tip box 104 may provide sufficient force to decouple the undesired pipette tips 132 from the desired pipette tips 134 and/or the mandrels 130. It is appreciated that the coordinated movement 136 can include any number of movements that include a horizontal and vertical component within the pipette tip box 104 to press the pipette tips 110 against the pipette tip box 104. In some embodiments, the coordinated movement 136 may begin from the center of each concavity within the pipette tip box 104 for storing the pipette tips 110, wherein the pipette tips 110 are partially inserted within the pipette tip box 104. The mandrels may then move the pipette tips diagonally to a corner of the concavities within the pipette tip box 104 before moving the pipette tips 110 to each of the other corners of the concavities within pipette tip box 104. The mandrels 130 may then return the pipette tips 110 to the center of the concavities within the pipette tip box 104 and allow the undesired pipette tips to dislodge into the pipette tip box 104. In some embodiments, the concavities within the pipette tip box 104 for receiving the pipette tips 110 may define a cylindrical space. In some embodiments, the coordinated movement 136 may be adjusted to match any type of concavity within the pipette tip box 104 by pressing the pipette tips 110 against the pipette tip box 104. In some embodiments, the coordinated movement 136 may include a radial motion having a horizontal and vertical component. In some embodiments, the coordinated movement may only include motion in the horizontal direction. In some embodiments, the coordinated movement may only include motion in the vertical direction.

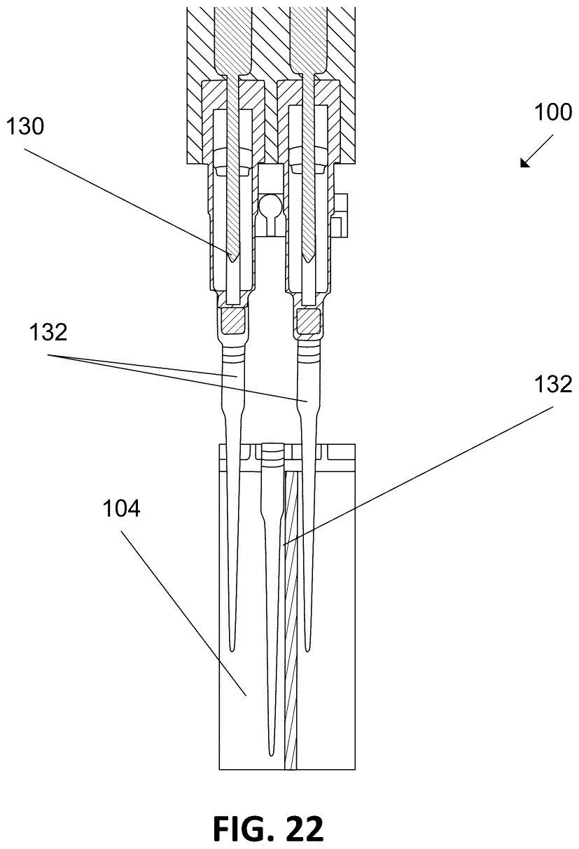

FIG. 22 shows a transverse cross-sectional view of the mandrels 130, the pipette tip box 104, and pipette tips 110 depicting the fourth step 286 of FIG. 18 when the desired pipette tips 134 have been fully removed from the pipette tip box 104 and coupled to the mandrel 130 with any undesired pipette tips 132 decoupled from the mandrel 130. As can be seen in this figure, the desired pipette tips 134 remain coupled to the mandrels 130 while the undesired pipette tip 132 has been dislodged from the mandrel 130 and returned to the pipette tip box 104.

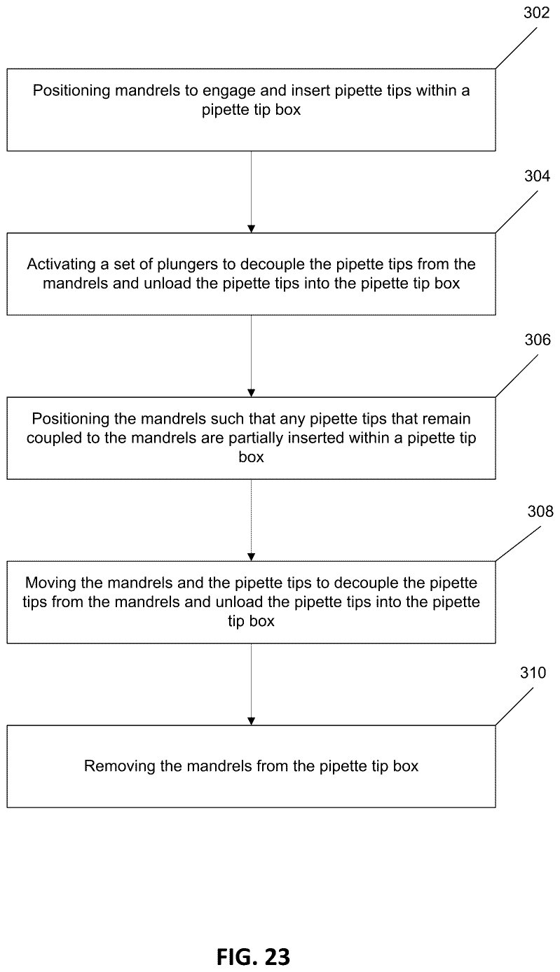

FIG. 23 shows a flowchart depicting the unloading of pipette tips from the mandrels into the pipette tip box in accordance with example embodiments of the pipetting instrument of FIG. 1.

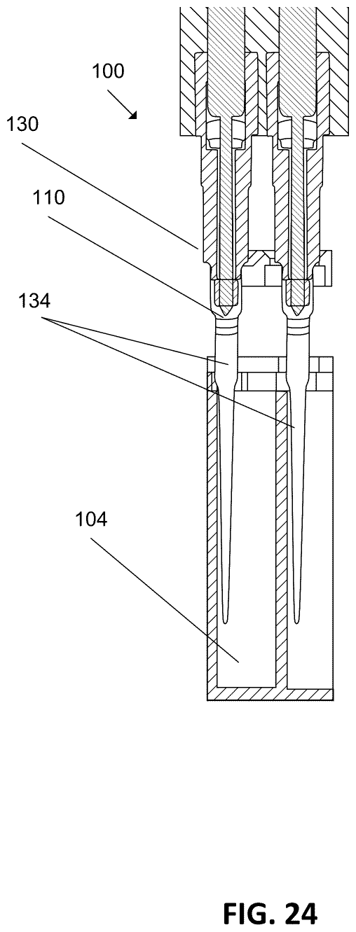

This figure includes a first step 302 for positioning the mandrels 130 to engage and insert pipette tips 110 within a pipette tip box 104, a second step 304 for activating a set of plungers to decouple the pipette tips 110 from the mandrel 130 and unload the pipette tips 110 into the pipette tip box 104, a third step 306 for positioning the mandrels 130 such that any pipette tips 110 that remain coupled to the mandrels 130 are partially inserted within a pipette tip box 104, a fourth step 308 for moving the mandrels 130 and the pipette tips 110 to decouple the pipette tips 110 from the mandrels 130 and unload the pipette tips 110 into the pipette tip box 104, and a fifth step 310 for removing the mandrels 130 from the pipette tip box 104. Examples of the each of the first step, the second step, the third step, the fourth step, and the fifth step are illustrated and described in further detail with reference to FIGS. 24, 25, 26, 27, and 28, respectively.

FIG. 24 shows a transverse cross-sectional view of the mandrels 130, the pipette tip box 104, and the pipette tips 110 depicting the first step 302 of FIG. 23, where the mandrels 130 are positioned to engage and insert the pipette tips 110 within the pipette tip box 104. In this figure, the mandrels 130 are inserted at least partially into the pipette tips 110. Examples for engaging and inserting the mandrels 130 into the pipette tips 110 are illustrated and described in further detail with reference to FIG. 19.

FIG. 25 shows a transverse cross-sectional view of the mandrels 130, the pipette tip box 104, and the pipette tips 110 depicting the second step 304 of FIG. 23, where plungers are activated along a plunger pathway 312 on the mandrels 130 to decouple the pipette tips 110 from the mandrels 130 and unload the pipette tips 110 into the pipette tip box 104.

The plunger pathway 312 defines a pathway for a plunger within each of the mandrels 130 to unload the desired pipette tips 134 into the pipette tip box 104. The plungers are configured to apply a downward force along the plunger pathway 312 toward the bottom of the mandrels 130 to dislodge the desired pipette tips 134. The desired pipette tips 134 remain partially inserted within the pipette tip box 104 to guide the desired pipette tips 134 into the pipette tip box 104. In some embodiments, undesired pipette tips 132 may be mechanically or electrically coupled to the mandrels 130, the desired pipette tips 134, or both. In some embodiments, the desired pipette tips 134 may be defined by a pattern of every other pipette tip 110, where in this figure both of the pipette tips 110 are desired pipette tips 134. In some embodiments, an undesired pipette tip 132 may be mechanically or electrostatically coupled to the mandrels 130, the desired pipette tips 134, or both in between the desired pipette tips 134. In some embodiments, if the plungers fail to decouple the desired pipette tips 134 from the mandrels 130, then the plungers may be reactivated as necessary to decouple the desired pipette tips 134 from the mandrels 130 along the plunger pathway 312.

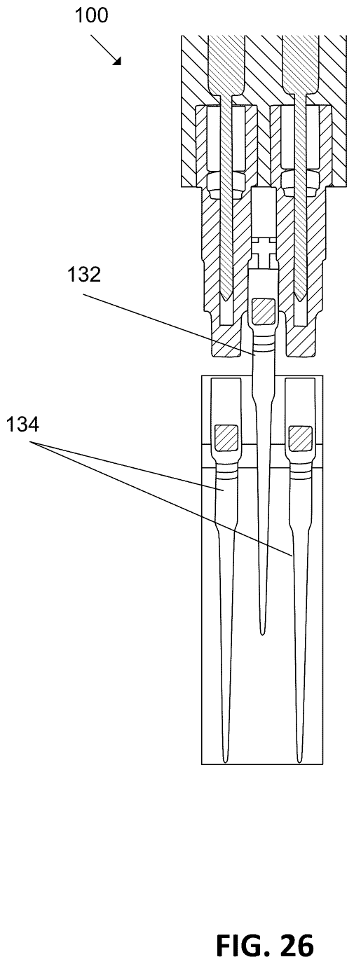

FIG. 26 shows a transverse cross-sectional view of the mandrels 130, the pipette tip box 104, and the pipette tips 110 depicting the third step 306 of FIG. 23, where the mandrels 130 are positioned such that any pipette tips 110 that remain coupled to the mandrels 130 are partially inserted within the pipette tip box 104. In this figure, the desired pipette tips 134 have been removed from the mandrels 130 in the second step 304 and only a single undesired pipette tip 132 remains coupled to the mandrel.

FIG. 27 shows a diagram depicting a coordinated movement 136 of the mandrels 130 to dislodge any undesired pipette tips 132 from the mandrels 130 depicting the fourth step 308 of FIG. 23. Examples illustrating the coordinated movement 136 of the mandrels 130 are illustrated and described in further detail with reference to FIG. 21.

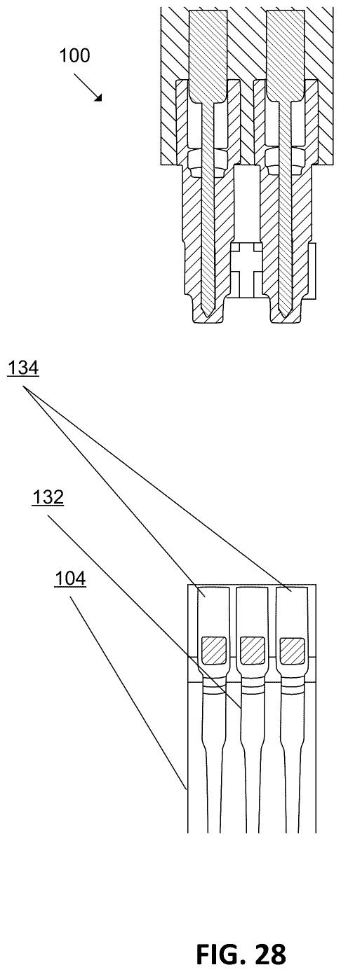

FIG. 28 shows a transverse cross-sectional view of the mandrels 130, the pipette tip box 104, and the pipette tips 110 depicting the fifth step 310 of FIG. 23, wherein the mandrels 130 are removed from the pipette tip box 104 and each of the pipette tips 110 have been unloaded into the pipette tip box 104.

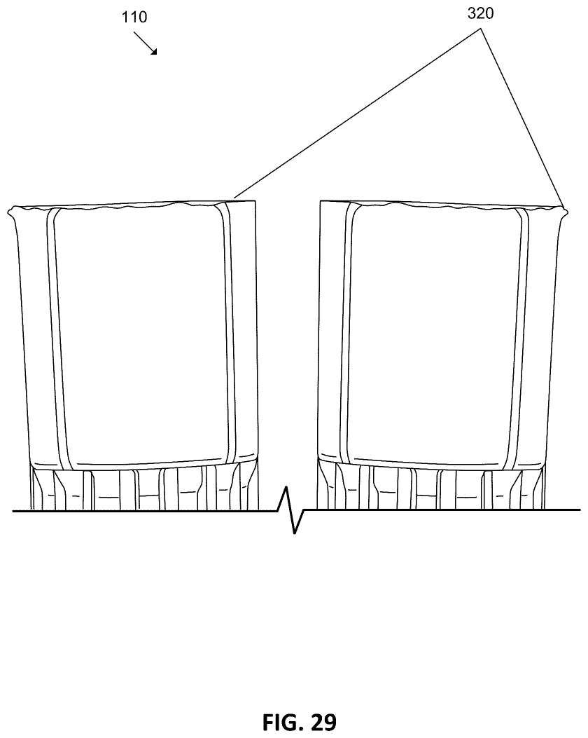

FIG. 29 shows a front view of the top of pipette tips 110 having pipette tip features 320 that may affect the process of loading or unloading desired pipette tips. In some embodiments, the pipette tip features 320 may contribute to the loading of an undesired pipette tip 132 onto a mandrel 130 or a desired pipette tip 134. In this figure, the pipette tip 110 on the left-hand side includes a filament that can couple to an adjacent pipette tip 110 that is stored in a pipette tip box 104. In this figure, the pipette tip 110 on the right-hand side includes a protrusion that is not flush with the cylindrical head of the pipette tip 110. A protrusion from the pipette tip 110 can couple to adjacent pipette tips 110 that are stored in a pipette tip box 104. It is contemplated that many kinds of pipette tip features on pipette tips 110 can engage adjacent pipette tips 110 and affect the process of loading or unloading desired pipette tips, and the above examples are not restrictive of these pipette tip features 320.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

1. A pipetting instrument for loading and dispensing a sample, the pipetting instrument comprising:
an automated liquid pipettor comprising a deck for supporting a pipette tip box comprising pipette tips, and mandrels for engaging the pipette tips and withdrawing at least some of the pipette tips from the pipette tip box; and
a controller configured to control the automated liquid pipettor, the controller further configured to execute a pipette tip dislodging operation to dislodge any undesired pipette tips that are withdrawn from the pipette tip box using the mandrels.

2. (canceled)

3. The pipetting instrument according to claim 1, wherein the pipette tips have a spacing between adjacent pipette tips in the pipette tip box that is less than 0.30 millimeters.

4. The pipetting instrument according to claim 1, wherein the automated liquid pipettor further comprises a motorized positioning system configured to position the mandrels.

5. The pipetting instrument according to claim 4, wherein the motorized positioning system comprises at least one motor and is configured to move the mandrels in three dimensions.

6. The pipetting instrument according to claim 5, wherein the at least one motor is mechanically coupled to drive the mandrels horizontally about an axis.

7. The pipetting instrument according to claim 5, wherein the mandrels are movable along an X-axis and a Y-axis by a motorized gantry, the mandrels being coupled to the motorized gantry, wherein the mandrels are configured to move along a Z-axis by adjusting a height of a pod, wherein the pod is positioned between the motorized gantry and the mandrels.

8. The automated liquid pipettor according to claim 1, further comprising a sensor configured to sense the undesired pipette tips that are coupled to the mandrels or the desired pipette tips.

9. A method for loading a set of pipette tips onto an automated liquid pipettor, the method comprising:
coupling desired pipette tips to mandrels by positioning the mandrels and engaging the pipette tips with the mandrels;
lifting the mandrels to partially remove the desired pipette tips from a pipette tip box, and lifting at least one undesired pipette tip along with the desired pipette tips;
moving the mandrels to dislodge the at least one undesired pipette tip from the mandrels, causing the at least one undesired pipette tip to return to the pipette tip box while the set of desired pipette tips remain coupled to the mandrels; and
lifting the mandrels to fully remove the desired pipette tips from the pipette tip box.

10. The method of claim 9, wherein the mandrels are coupled to the desired pipette tips using a friction fit.

11. The method according to claim 9, wherein the at least one undesired pipette tip is coupled to a desired pipette tip and not coupled to the mandrels.

12. The method according to claim 9, wherein the mandrels are moved in a motion comprising a horizontal component to cause the pipette tips to press against the pipette tip box.

13. The method according to claim 9, wherein the mandrels are moved in a motion comprising a vertical component.

14. The method according to claim 9, wherein the mandrels are moved in a motion comprising a horizontal and a vertical component.

15. (canceled)

16. (canceled)

17. The method according to claim 9, further comprising, using a sensor, sensing whether any undesired pipette tips are coupled to the mandrels or any desired pipette tips and identifying a population of mandrels and pipette tips to move that are coupled to the undesired pipette tips.

18. A method for unloading one or more pipette tips from an automated liquid pipettor, the method comprising:
positioning mandrels to engage and insert the pipette tips within a pipette tip box;
activating a set of plungers to decouple the one or more pipette tips from the mandrels and unload the pipette tips into the pipette tip box;
positioning the mandrels to partially insert any pipette tips that remain coupled to the mandrels into the pipette tip box;
moving the mandrels and the pipette tips to decouple the pipette tips from the mandrels and unload the pipette tips into the pipette tip box; and
removing the mandrels from the pipette tip box.

19. The method of claim 18, wherein positioning the mandrels to engage and insert the pipette tips within a pipette tip box further comprises fully inserting the pipette tips into the pipette tip box.

20. The method according to claim 18, wherein moving the mandrels and the pipette tips to decouple the pipette tips from the mandrels further comprises moving the mandrels in a motion comprising a horizontal component within the pipette tip box to press the pipette tips against the pipette tip box.

21. The method according to claim 18, wherein moving the mandrels and the pipette tips to decouple the pipette tips from the mandrels further comprises moving the mandrels in a motion comprising a vertical component within the pipette tip box to press the pipette tips against the pipette tip box.

22. The method according to claim 18, wherein moving the mandrels and the pipette tips to decouple the pipette tips from the mandrels further comprises moving the mandrels in a motion comprising a horizontal and vertical component within the pipette tip box to press the pipette tips against the pipette tip box.

23. The method according to claim 18, wherein moving the mandrels and the pipette tips to decouple the pipette tips from the mandrels further comprises moving the mandrels in a radial motion comprising a horizontal and vertical component within the pipette tip box to press the pipette tips against the pipette tip box.

24. (canceled)
